(19) United States
(12) Patent Application Publication
(10) Pub. No.: US 2020/0262720 A1
(43) Pub. Date: Aug. 20, 2020

(54) RUBBER-BASED SUBSTANCE FOR REMOVING SATURATED AND UNSATURATED FATS, OIL AND PETROLEUM PRODUCTS, AS WELL AS ORGANIC SOLVENTS

(71) Applicant: Five Stones Holdings Corp., Littleton, MA (US)

(72) Inventor: Oleksandr Yuriiovych Mykytiuk, Kyiv (UA)

(21) Appl. No.: 16/651,556

(22) PCT Filed: Sep. 28, 2018
(86) PCT No.: PCT/UA2018/000109

§ 371 Date: Mar. 27, 2020

(30) Foreign Application Priority Data
Sep. 29, 2017 (UA) A 2017 09563

(51) Int. Cl. C02F 1/28; C02F 1/68; C09K 3/32

(52) U.S. Cl. CPC C02F 1/285; C02F 2103/007; C09K 3/32; C02F 1/681

(57) ABSTRACT

The present invention relates to a rubber-based substance for removing saturated and unsaturated fats, oils and petroleum products, as well as organic solvents from the aqueous surface, and/or an aqueous emulsion and aqueous solutions of organic solvents. In addition, the present invention also relates to a process for producing a given rubber-based substance. More specifically, the present invention relates to the application of this rubber-based substance for removing saturated and unsaturated fats, petroleum and petroleum products, as well as organic solvents from the water surface of open water bodies, including seas and oceans.

### FIELD OF THE INVENTION

The present invention relates to a rubber-based substance for removing saturated and unsaturated fats, oils and petroleum products, as well as organic solvents from the aqueous surface, and/or an aqueous emulsion and aqueous solutions of organic solvents. In addition, the present invention also relates to a process for producing a given substance on a rubber basis. More specifically, the present invention relates to the use of this rubber-based substance for removing saturated and unsaturated fats, oils and petroleum products, as well as organic solvents from the aqueous surface.

### BACKGROUND OF THE INVENTION

Sorbent based on worn car tires for cleaning the water surface from oil and petroleum products (pages 80-81, article number 6-2 (27) in the magazine “EURASIAN UNION OF SCIENTISTS”, publishing house MOC LLC, Moscow, 2016, ISSN: 2411-6467) is a prototype of a rubber-based substance for removing saturated and unsaturated fats, oil and petroleum products, as well as organic solvents from the water surface.

This article discusses the effectiveness of the proposed sorbent for cleaning the water surface from oil and petroleum products, and states the high absorption capacity for oil and petroleum products, the reliability for edible oil and petroleum products extraction for the rubber crumb, the possibility of oil spill localization and the protection for the shore edge.

A rubber-based substance for removing saturated and unsaturated fats, oil and petroleum products, as well as organic solvents from the aqueous surface and/or aqueous emulsion and aqueous solutions of organic solvents differs from the prototype by the use of not a rubber crumb as a sorbent for oil and petroleum products, but rubber regenerate mechanically activated at a moderate temperature from 70 to 90° C., which has a developed surface and active centers in comparison with rubber crumb.

Thermal and mechanical energy is directed to the destruction of intermolecular bonds, which leads to the formation of a developed surface on the particles in the form of flakes with hydrophobic properties and active centers absorbing oil and petroleum products.

In addition, the difference of the rubber-based substance for removing saturated and unsaturated fats, oil and petroleum products, as well as organic solvents from the water surface is that the average size of mechanically activated rubber regenerate is 500 microns.

The use of mechanically activated rubber as an effective filler for bitumen is known (pages 61-66, number 6 (51) in the article of the “VESTNIK VSGUTU”, the publishing house of the VSGUTU, Ulan-Ude, 2014, ISSN: 2413-1997).

This paper presents the research results for the properties of rubber crumb, activated by a mechanochemical method, for modifying road bitumen. To study the properties of mechanically activated rubber crumbs, the rubber of the industrial brand B-14 was used as a model matrix. The efficiency of modification with mechanically activated rubber crumb as an elastomeric matrix and bitumen is shown.

A sorbent for removing oil, petroleum products and other saturated and unsaturated fats from aqueous emulsions based on the mechanically activated rubber is more efficient, has a wider range of substances removed from the emulsion, and requires less time for removal.

### BRIEF DESCRIPTION

The purpose of the present invention is to manufacture and use a rubber-based substance for removing saturated and unsaturated fats, oils and petroleum products, as well as organic solvents from the aqueous surface, and/or an aqueous emulsion and aqueous solutions of organic solvents.

The inventors found that this rubber-based substance is weakly hydrophobic and is saturated with water up to 30% by weight after 4-6 hours contact of the rubber-based substance with water. There is no further growth of the rubber-based substance saturation with water. This rubber-based substance absorbs saturated, unsaturated fats, oils and petroleum products, as well as organic solvents. Rubber absorbs organic solvents and the vast majority of petroleum products. Saturated, unsaturated fats and oil form a suspension resistant to other substances with a rubber-based substance due to its surface with a developed structure and the presence of a large number of active centers, which does not stratify over 48 hours and is not mixed with water.

The present invention also provides a method for obtaining a rubber-based substance for removing saturated and unsaturated fats, oil and petroleum products, as well as organic solvents from the aqueous surface, and/or an aqueous emulsion and aqueous solutions of organic solvents. Another task of the present invention is the use of a rubber-based substance for removing saturated and unsaturated fats, oils and petroleum products, as well as organic solvents from the aqueous surface, and/or an aqueous emulsion and aqueous solutions of organic solvents.

Other advantages and embodiments of the present invention will be apparent from the following description.

### DESCRIPTION

In accordance with the present invention, a new rubber-based substance for removing saturated and unsaturated fats, petroleum and petroleum products, as well as organic solvents from the aqueous surface, and/or an aqueous emulsion and aqueous solutions of organic solvents is obtained unexpectedly.

The rubber-based substance is capable, according to the present invention, to be saturated with water up to 30% by weight after 4-6 hours contact with water. It absorbs saturated, unsaturated fats, oil and petroleum products, as well as organic solvents. Rubber absorbs organic solvents and the vast majority of petroleum products.

Saturated, unsaturated fats and oil form a suspension resistant to other substances with a rubber-based substance due to its surface with a developed structure and the presence of a large number of active centers, which does not stratify over 48 hours and is not mixed with water.

The rubber-based substance contains from 60% to 85% of synthetic rubber, from 0.5% to 4% of sulfur, and from 10% to 25% of carbon. The fractions size of the rubber-based substance is within the range of 0.1 to 1 mm. The particles have a petal shape with a developed surface and a large number of active centers. The structure of the rubber-based substance is amorphous and soft, in which the pores are absent.

The method of obtaining a rubber-based substance for removing saturated and unsaturated fats, oils and petroleum products, as well as organic solvents from the aqueous surface, and/or an aqueous emulsion and aqueous solutions of organic solvents consists in the mechanical processing of raw materials (industrial rubber articles) at a temperature up to 100° C. with a cooling of the working unit in a specially designed screw allowing the creation of high local pressure on the raw material, which leads to the destruction of the rubber structure due to a shear displacement in its structure, chemical bonds destruction, creating numerous active sites and activation of rubber, which then provides substances based on natural rubber with properties declared according to the present invention.

The use of a rubber-based substance for removing saturated and unsaturated fats, oil and petroleum products, as well as organic solvents from the aqueous surface and/or aqueous emulsion and aqueous solutions of organic solvents occurs when oil and petroleum products are spilled in open water bodies, including seas and oceans, by localization of places where the oil and petroleum products were spilled. On addition, a rubber-based substance is used for cleaning reservoirs from oil and oil products, industrial water purification and drainage from landfills of solid household wastes from saturated and unsaturated fats, petroleum and petroleum products, as well as from organic solvents.

Thus, a rubber-based substance for removing saturated and unsaturated fats, oils and petroleum products, as well as organic solvents from the aqueous surface and/or an aqueous emulsion and aqueous solutions of organic solvents can be used alone or in combination with a carbon based powder substance

The rubber-based substance for removing saturated and unsaturated fats, oil and petroleum products, as well as organic solvents from the aqueous surface and/or aqueous emulsion and aqueous solutions of organic solvents is more efficient and has a wider range of substances removed from the emulsion and requires much less time for its removal.

1. The rubber-based substance for removing saturated and unsaturated fats, oils and petroleum products, as well as organic solvents from the aqueous surface, and/or an aqueous emulsion and aqueous solutions of organic solvents contains:
from 60% to 85% of synthetic rubber,
from 0.5% to 4% of sulfur;
from 10% to 25% of carbon.

2. The rubber-based substance of claim 1, wherein has the average the fractions size of the rubber-based substance from 0.1 to 1 mm.

3. The rubber-based substance of claim 1, wherein the structure of the rubber-based substance is amorphous and mild, and has no pores.

4. The rubber-based substance of claim 1, wherein the substance is hydrophobic, a saturation with water up to 30% by weight occurs after 4-6 hours contact of the substance with water.

5. The rubber-based substance of claims 1-4, wherein a mechanically activated at moderate temperatures from 70 to 90° C. rubber regenerate with a developed surface and active centers is used as a sorbent for oil and petroleum products instead of rubber crumb.

6. The rubber-based substance of claims 1-5, wherein the thermal and mechanical energy is directed to the destruction of intermolecular bonds, which leads to the formation of a developed surface for the particles in the form of flakes with hydrophobic properties and active centers absorbing oil and petroleum products.

7. The rubber-based substance of claims 1-6, wherein the average size of the mechanically activated rubber regenerate is 500 microns.

8. The rubber-based substance of claims 1-7, wherein it is more efficient and has a wider range of substances removed from the emulsion and requires less time for its elimination.

9. The rubber-based substance of claims 1-8, wherein it can be used alone or in combination with a carbon-based powdered substance.

10. A process for producing a rubber-based substance for removing saturated and unsaturated fats, oil and petroleum products, as well as organic solvents from the aqueous surface, and/or an aqueous emulsion and aqueous solutions of organic solvents, which consists in the mechanical processing of raw materials (industrial rubber articles) at a temperature of up to 100° C. with cooling of the working unit, in a specially designed screw, which allows to create high local pressure on the raw material, which leads to the destruction of the rubber structure due to a shear shift in its structure of chemical bonds break, creating numerous active sites and rubber activation, which then provides the rubber-based substance with a properties of the invention.

11. The use of a rubber-based substance for removing saturated and unsaturated fats, oil and petroleum products, as well as organic solvents from the aqueous surface and/or an aqueous emulsion and aqueous solutions of organic solvents, which leads to the localization of oil and petroleum spills, as well as spills of organic solvents from the water surface of open water bodies, including seas and oceans.

12. The use of a rubber-based substance of claim 11, wherein the reservoirs cleaning from oil and petroleum products is carried out.

13. The use of a rubber-based substance of claim 11, wherein the treatment of industrial water and drainage from solid domestic solid waste landfills from saturated and unsaturated fats, oil and petroleum products is parried out, as well as from organic solvents from the water surface of open water bodies, including seas and oceans.
